(19) United States
(12) Patent Application Publication
(10) Pub. No.: US 2007/0044978 A1
(43) Pub. Date: Mar. 1, 2007

(54) Multipurpose fluid distribution system

(76) Inventor: Bryce Dean Cohen, Englewood, CO (US)

Correspondence Address: JONDLE & ASSOCIATES P.C., 858 HAPPY CANYON ROAD SUITE 230, CASTLE ROCK, CO, 80108, US

(21) Appl. No.: 11/215,593

(22) Filed: Aug. 30, 2005

(51) Int. Cl. A62C 35/00; B05B 1/14; A62C 2/08

(52) U.S. Cl. 169/5; 169/16; 239/548; 239/551

(57) ABSTRACT

A multipurpose fluid distribution system including a network of fluid distribution heads associated with a landscape. Also included is a water supply feeding the network of fluid distribution heads. The fluid distribution heads may be typical irrigation or sprinkler heads or specialized heads useful for reaching portions of a structure or landscape which are not typically irrigated such as the roofs of buildings. Also included in the multipurpose fluid distribution system is a series of distribution valves operatively disposed between the water supply and the network of fluid distribution heads. The system can be controlled with a control unit associated with the distribution valves which is configured to automatically open select distribution valves or open select distribution valves according to manual input. The control unit is configured to open certain valves under predetermined conditions or upon a select schedule for the routine irrigation of the landscape with water from the water supply. In addition, the control unit is configured to open select distribution valves for the nonroutine application of water to the landscape in the event a fire sensor associated with the control unit detects an approaching wildfire.

### TECHNICAL FIELD

The present invention is directed toward a multipurpose fluid distribution system, and more particularly toward an automated system for the routine irrigation of a landscape and nonroutine application of water, fire suppressant, or fire retardant fluid to a landscape and associated structures in the event of a fire.

### BACKGROUND ART

Wildfires are an annual occurrence in arid or semiarid regions of the United States such as southern California and Colorado. Wildfires are often ignited by natural phenomena such as lightning storms or are caused by human negligence. Once a wildfire is ignited, it may consume substantial acreage which can include valuable residential or commercial structures and associated landscaping.

Often, a relatively small wildfire can be contained by local authorities before significant damage to structures or landscaping occurs. However, in the case of a large, fast moving, and uncontained wildfire, firefighting authorities may be unable to contain the progress of the wildfire before significant property damage occurs. In such an instance, it would be extremely foolhardy for a property owner to attempt to manually apply fire retardant or fire suppressant to his or her structures or landscape. The risk of injury or death is simply too great to justify manual fire suppression efforts.

Several systems for home and property protection from wildfires are known. Typically, the prior art systems are more or less automated, and feature the application of a fire retardant or suppressant such as water or a chemical designed for fire control to structures and landscape as a wildfire approaches. The prior art systems are manually actuated or triggered by various types of fire sensors and detectors. The prior art systems all feature dedicated spray heads, sprinklers, or other application nozzles of various configurations implemented to direct fire control fluids toward structures and landscape features.

The prior art automated fire suppression systems are designed to fulfill a single purpose. These systems protect real property from approaching wildfires by applying fire retardant or suppression fluids. The prior art systems can be rather complex, costly, and maintenance intensive. Thus, a substantial disadvantage of the prior art systems is the large investment a property owner must make in an automated system which hopefully will never be used. For many property owners, the investment in a single purpose system is too large to justify the potential benefit of the protection of landscaping and structures in the event of a wildfire.

Wildfires are naturally more common in arid and semiarid regions of the country. These same regions, the west and southwest portions of the United States for example, are also the regions where landscape irrigation is most necessary if a well planted and thriving landscape is to be maintained through the summer and fall months. An appropriate automated irrigation system is also a substantial investment made by many property owners in arid and semiarid regions of the country. Prior art exterior landscape and structure fire suppression systems and prior art irrigation systems are each relatively complex and potentially expensive systems, each of which is directed toward a single purpose.

The present invention is directed toward overcoming one or more of the problems discussed above.

### SUMMARY OF THE INVENTION

One aspect of the present invention is a multipurpose fluid distribution system including a network of fluid distribution heads associated with a landscape. Also included is a water supply feeding the network of fluid distribution heads. The fluid distribution heads may be typical irrigation or sprinkler heads or specialized heads useful for reaching portions of a structure or landscape which are not typically irrigated such as the roofs of buildings.

Also included in the multipurpose fluid distribution system is a series of distribution valves operatively disposed between the water supply and the network of fluid distribution heads. The system can be controlled with a control unit associated with the distribution valves which is configured to automatically open select distribution valves or open select distribution valves according to input. The control unit is configured to open certain valves under predetermined conditions or upon a select schedule for the routine irrigation of the landscape with water from the water supply. In addition, the control unit is configured to open select distribution valves for the nonroutine application of water to the landscape in the event a fire sensor associated with the control unit detects an approaching wildfire.

The multipurpose fluid distribution system may have a portion of the network of fluid distribution heads specifically associated with a structure situated on the landscape. In addition, a fire retardant supply separate from the water supply may be connected in fluid communication with the series of valves. In such an instance, input from the fire sensor may cause the control unit to open select distribution valves causing the application of fire retardant to the structure or landscape. The system may further include a mixing valve receiving input from both the water supply and the fire retardant supply in fluid communication with the series of distribution valves. Thus, input from the fire sensor can cause the control unit to open select distribution valves causing the application of a mixture of water and fire retardant to the structure or various aspects of the landscape. Similarly, an alternative or third fluid supply of fire suppressant may be included in the system. Thus, the system may be configured to selectively apply one, a group of, or all of the available fluids, water, fire suppressant, and fire retardant, through select distribution valves upon input from the fire sensor.

Another aspect of the present invention includes a dedicated pump in fluid communication with one or more of the fluid supplies and the series of distribution valves. The system may also include a backup power supply in electrical communication with the pump. In this aspect of the present invention, fluid may be applied to the landscape or structure in the event that normal utility services are disrupted. The backup power supply may include a generator configured to supply electricity to the pump and a battery which is suitable for supplying necessary electricity to start the generator. In addition, a switch may be included in the system which allows the selective application of electrical power to the system from the backup electrical power supply. In the event of a non-fire related power failure in the normal utility service, the backup generator may also supply electrical back up power back to electrical appliances and apparatus associated with the landscape or structure.

Another aspect of the present invention is a multipurpose fluid distribution system including a remote control unit located away from the automatic control unit and in communication with the automatic control unit. For example, the remote control unit might be a computer located at another property accessible to the property owner. Alternatively, the remote control unit could be located with an agency hired by the property owner to monitor signals from the fire sensor or other alarms. The remote control unit may be configured to send commands to the control unit, causing the control unit to open select distribution valves for nonroutine application of water or fire suppressant/retardant chemicals to the landscape or structure for fire control. It is advantageous to have the remote control unit communicate with the control unit over a wireless communication link. Thus, communication with the control unit can be maintained in the event telephone lines or other conventional communication links are disrupted by a wildfire.

The fire sensor included in the system may be a humidity sensor configured to detect the drop in humidity preceding a wildfire or a temperature or heat sensor configured to detect the rise in temperature preceding a wildfire. Furthermore, the system may include a precipitation sensor, also in communication with the control unit and providing input to the control unit, optimizing the control of routine irrigation activities.

Another aspect of the present invention is a method of automatically distributing fluids to various portions of a landscape and associated structures, said method being implemented with the apparatus described above.

### BRIEF DESCRIPTION OF THE DRAWINGS

FIG. 1 is a schematic diagram of a multipurpose fluid distribution system consistent with the present invention.

### DETAILED DESCRIPTION OF THE PREFERRED EMBODIMENT

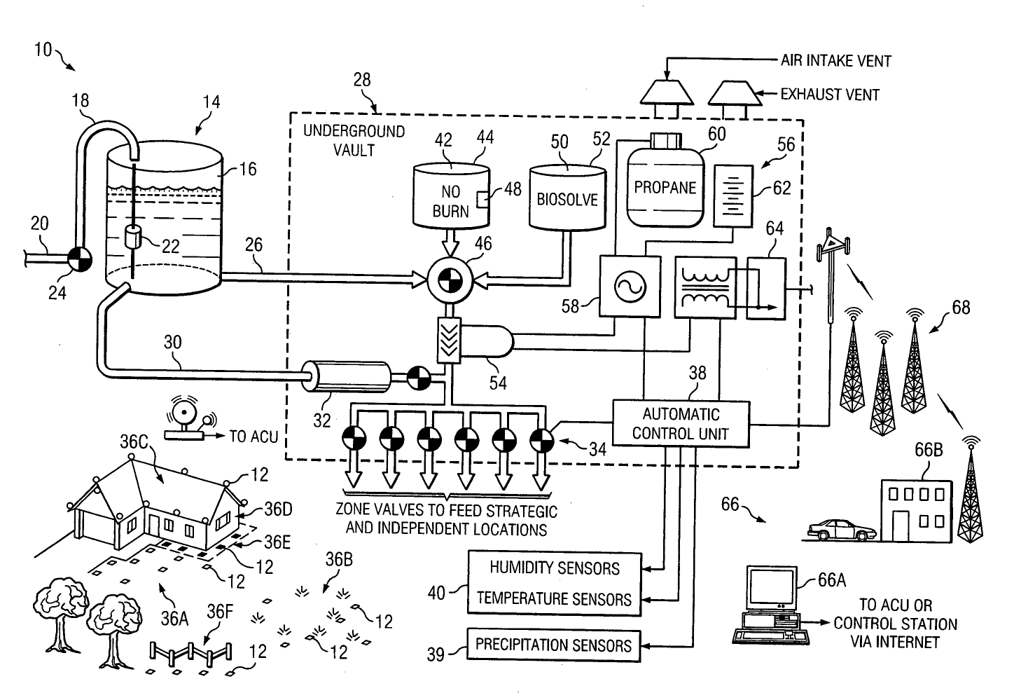

A multipurpose fluid distribution system 10 is shown schematically in FIG. 1. The system 10 includes a network of fluid distribution heads 12 associated with a landscape. The individual fluid distribution heads 12 of the network may be selected from various available types to accomplish specific irrigation and/or fire control purposes, depending on the location of the particular head 12. All of the various types of irrigation heads known in the irrigating arts are suitable for the implementation of the present invention. For example, conventional popup sprinkler heads may be associated with grassy areas of a landscape; gear driven heads may be installed in open fields; microjets and drip emitters may be installed in flower or vegetable beds. The foregoing list of possible heads is not exhaustive, and is not intended to be limiting in any way. Because of the multipurpose nature of the present fluid distribution system 10, it is desirable that individual heads 12 used above ground be made of heat tolerant material such as brass or copper. As is discussed in detail below, certain heads 12 may be associated with structures or placed in other nontypical locations.

The multipurpose fluid distribution system 10 also includes a water supply 14. As shown in FIG. 1, the water supply 14 may be a standalone tank 16 such as a conventional water storage tank. The tank 16 may be associated with a fill tube 18 connected to a constant pressure water source 20 such as a municipal water supply. A float device 22 configured to open a fill valve 24 may be employed to assure that the water level in the tank 16 does not drop below a designated level.

Alternatively, the water supply 14 may be a direct tap to a constant pressure water source 20 such as a municipal water supply. In addition, other water holding structures such as swimming pools or natural water supplies such as wells, ponds, or rivers could be implemented as the water supply 14 of the present invention.

The tank 16 may be situated above or below ground. It is desirable, but not required, that any tank 16 used as a water supply 14 have a capacity of at least 10,000 gallons. A tank 16 of this size would have the capacity to supply water through six conventional irrigation zones with the irrigation heads 12 running simultaneously at the rate of 14 gallons/minute for two hours.

A screened and/or filtered draw tube 26 may be employed to move water by gravity toward an underground vault 28 housing other components of the multipurpose fluid distribution system 10. The draw tube 26 must be sized with an appropriate diameter to supply water sufficient to run all irrigation or fire control zones simultaneously.

It is also desirable to have one or more circulation tubes 30 plumbed into the system 10 to provide for the slow circulation of stored water which might otherwise become stagnant. In addition, a heater 32 may be associated with the circulation tube 30 to prevent the freezing of water throughout the system 10 in the winter. The heater 32 may be located within the underground vault 28.

The multipurpose fluid distribution system 10 will also include a series of distribution valves 34 disposed in fluid communication between the water supply 14 and the network of fluid distribution heads 12. Typically, multiple heads 12 will be fed from each of the distribution valves 34. It is customary to refer to a group of heads 12 supplied by each distribution valve 34 as a zone 36. Numerous types of zones 36 may be configured for the implementation of the system 10. FIG. 1 illustrates a lawn zone 36A, an open field zone 36B, a rooftop zone 36C, an exterior wall zone 36D, a bedded plant zone 36E, and a perimeter zone 36F. The present invention is not limited to these zones 36; any suitable zone 36 may be configured at the discretion of the property owner within the scope of the present invention. The type and distribution of zones 36 will be determined by the features of the landscape and the presence of various structures. The distribution valves 34 feeding each zone 36 may be implemented with commonly available irrigation valves. Typically, such distribution valves 34 are controlled electromechanically by solenoids and diaphragms. Other types of distribution valves 34 are suitable for the implementation of the present invention.

The system 10 also includes an automatic control unit, or control unit 38. The control unit 38 is configured to electrically actuate the valves 34 for multiple purposes. The control unit 38 may be configured to open select valves 34 according to a select schedule for the routine irrigation of landscape features. The control unit 38 may be programmed to open distribution valves 34 daily, tri-weekly, or upon whatever routine schedule is appropriate for the landscape features being watered. In addition, the control unit 38 may be programmed to open distribution valves 34 under predetermined conditions relevant to irrigation. For example, a soil moisture sensor or precipitation sensor 39 may provide an input to the control unit 38, said input causing supplemental irrigation.

Additionally, the control unit 38 may be configured to receive an input from a fire sensor 40 indicating the approach of a wildfire. The fire sensor 40 may be a humidity sensor designed to detect the precipitous drop in humidity which precedes a wildfire front. Similarly, the fire sensor 40 may be a temperature or heat sensor designed to detect the dramatic rise in heat preceding a wildfire. The fire sensors 40 may also be configured to analyze the likelihood of a fire event based upon environmental conditions. Upon receipt of input from the fire sensor 40, the control unit 38 may open select distribution valves 34 for the nonroutine application of water to the landscape or nonroutine application of retardant to structures for fire control.

As is shown in FIG. 1, certain zones, zone 36C for example, may include fluid distribution heads 12 specifically associated with a structure. In addition, the system 10 may include a fire retardant supply 42 in fluid communication with the series of distribution valves 34. Thus, input from the fire sensor 40 can cause the control unit 38 to open select distribution valves 34 for the application of fire retardant from the fire retardant supply 42 to the structure or select landscape features.

The fire retardant supply 42 may be held in a tank 44 such as a molded plastic tank which can be readily obtained in various sizes and shapes. Typically, the fire retardant tank 44 will be maintained in the underground vault 28, however, the present invention is not limited to such a configuration. 50-200 gallons is an appropriate size for a fire retardant tank 44 installed on a typical residential property, however, the ultimate size chosen for the fire retardant supply 42 will depend on the type of retardant used and the total square footage of surface potentially requiring coverage.

Some fire retardants are delivered in concentrated form. Such retardants are designed to be mixed with water immediately prior to application. Mixing can be accomplished with a mixing valve 46 receiving input from the water supply 14 and the fire retardant supply 42, said mixing valve 46 having an output in fluid communication with the series of distribution valves 34. Thus, input from the fire sensor 40 can cause the control unit 38 to open select distribution valves 34, providing for the application of a mixture of water and fire retardant to a structure or landscape through appropriate zones 36.

Other types of retardant are delivered for use without mixing, eliminating the need for a mixing valve 46. In any installation, a refill notification gauge 48 would preferably be associated with the fire retardant tank 44 to assure that the fire retardant supply 42 is maintained at an appropriate level.

In addition to a fire retardant supply 42 which contains retardant specifically designed to be sprayed on a structure or landscape prior to a fire, and thus inhibit the ignition of the structure or landscape features, the system 10 may include a fire suppressant supply 50. Fire suppressant from the fire suppressant supply 50 may be applied to the landscape and structures in conjunction with retardant, however, suppressant is specifically formulated to put out actively burning fires.

The fire suppressant supply 50 may also be maintained in a suitably sized tank 52. Like the fire retardant supply 42, the fire suppressant supply 50 may be connected in fluid communication with the mixing valve 46, allowing the control unit 38 to distribute a mixture of water from the water supply 14 and suppressant from the suppressant supply 50 to appropriate zones 36. Typically, the fire suppressant tank 52 will also be in the 50-200 gallon range for a residential installation, with the ultimate size depending on any selected water to suppressant ratio and the total square footage of surface to cover. Preferably, the control unit 38 will be programmed to apply suppressant over intervals or through cycles in the event of a fire so that the suppressant supply does not run out before all active burn areas are extinguished.

The approach of a wildfire is quite likely to disrupt utility service to the property upon which the multipurpose fluid distribution system 10 is installed. The possible disruption of utility service emphasizes the advisability of maintaining the various fluid supplies 14, 42, 50 in tanks 16, 44, 52, respectively, rather than relying on municipal water supplies for fire control efforts. In addition, it is likely that electrical service and conventional communication lines such as telephone service will be disrupted by an approaching wildfire. Accordingly, it is desirable to have a dedicated pump 54 or multiple pumps included in the system 10 to pump fluid from the various supplies 14, 42, 50 through the distribution valves 34 to various zones 36. The dedicated pump 54 may be sized according to system 10 requirements, and will preferably have an interface in communication with the control unit 38. Also, the pump 54 may be connected to multiple alternative power sources including general utility service or a backup power supply 56 which may be implemented in the event normal power is disrupted.

It is advantageous to configure the backup power supply 56 to assure that all subsystems associated with the multipurpose fluid distribution system 10 remain operational in the event electrical power is interrupted. For example, the backup power supply 56 may include an A/C generator 58 suitable for supplying alternating current having a voltage and amperage sufficient to operate the pump 54. The A/C generator will have a dedicated fuel source such as the propane supply 60 shown in FIG. 1. In addition, a backup battery power supply 62 is advisable to supply suitable current to the control unit 38, the distribution valves 34, and other components of the system 10 requiring DC current to operate. The system 10 may also include a switch 64 for the selective application of electrical power to the system 10 from the backup electrical power supply 56.

The multipurpose fluid distribution system 10 of the present invention may also include a remotely located control unit 66 situated away from the control unit 38. The remote control unit 66 may be configured to override the control unit 38 from a safe distance in the event of a wildfire. As shown in FIG. 1, the remote control unit 66 could be a personal computer 66A located at an offsite location in a facility accessible to the property owner. Alternatively, the remote control unit 66 may be located at a dedicated control and monitoring station 66B housing personnel engaged by the property owner to monitor the alarm status of the subject property.

Since it is possible that telephone lines or other conventional communication links between the multipurpose fluid distribution system 10 and any remote control unit 66 will be disrupted in the event of a wildfire, it is desirable that a remote control unit 66 communicate with the control unit 38 via a wireless link 68. An embodiment of the present invention implemented with a control unit 38, backup power supply 56, remote control unit 66, and wireless link 68, all as described above, will have the capability to automatically implement fire control activities even though all normal utility services have been disrupted to the subject property. In addition, the remote control unit 66 will provide for supplemental human supervision and control of fire control efforts from a safe location.

While the invention has been particularly shown and described with reference to a number of embodiments, it would be understood by those skilled in the art that changes in the form and details may be made to the various embodiments disclosed herein without departing from the spirit and scope of the invention and that the various embodiments disclosed herein are not intended to act as limitations on the scope of the claims.

What is claimed is:

1. A multipurpose fluid distribution system comprising:
a network of fluid distribution heads associated with a landscape;
a series of distribution valves in fluid communication with the network of fluid distribution heads;
a water supply in fluid communication with the series of distribution valves;
a control unit operatively associated with the series of distribution valves configured to open select distribution valves under pre-determined conditions for the routine irrigation of the landscape; and
a fire sensor operatively associated with the control unit configured to provide an input to the control unit upon detection of a fire, the input causing the control unit to open select distribution valves for non-routine application of water to the landscape for fire control.

2. The multipurpose fluid distribution system of claim 1 further comprising the network of fluid distribution heads being associated with a structure.

3. The multipurpose fluid distribution system of claim 2 further comprising a fire retardant supply in fluid communication with the series of distribution valves such that input from the fire sensor causes the control unit to open select distribution valves for the application of a fire retardant to the structure.

4. The multipurpose fluid distribution system of claim 3 further comprising a mixing valve in fluid communication with the water supply, the fire retardant supply and the series of distribution valves, such that input from the fire sensor causes the control unit to open select distribution valves causing the application of a mixture of water and fire retardant to the structure.

5. The multipurpose fluid distribution system of claim 2 further comprising a fire suppressant supply in fluid communication with the series of distribution valves such that input from the fire sensor causes the control unit to open select distribution valves for the application of fire suppressant to the structure.

6. The multipurpose fluid distribution system of claim 5 further comprising a mixing valve in fluid communication with the water supply, the fire suppressant supply and the series of distribution valves, such that input from the fire sensor causes the control unit to open select distribution valves for the application of a mixture of water and fire retardant to the structure.

7. The multipurpose fluid distribution system of claim 1 further comprising a pump in fluid communication with the water supply and the series of distribution valves.

8. The multipurpose fluid distribution system of claim 7 further comprising a backup electrical power supply in electrical communication with the pump.

9. The multipurpose fluid distribution system of claim 8 wherein the backup power supply comprises:
a generator in electrical communication with the pump;
a battery in electrical communication with the control unit; and
a switch for the selective application of electrical power to the system from the backup electrical power supply.

10. The multipurpose fluid distribution system of claim 1 further comprising a remote control unit located away from the control unit and in communication with the control unit, the remote control unit being configured to send commands to the control unit causing the control unit to open select distribution valves for non-routine application of water to the landscape for fire control.

11. The multipurpose fluid distribution system of claim 10 further comprising a wireless communication link between the remote control unit and the control unit.

12. The multipurpose fluid distribution system of claim 1 wherein the fire sensor is selected from a group consisting of at least one of a humidity sensor, a temperature sensor and a heat sensor, the system further comprising a precipitation sensor in communication with the control unit.

13. A multipurpose fluid distribution system comprising:
a network of fluid distribution heads associated with a landscape;
a series of distribution valves in fluid communication with the network of fluid distribution heads;
a mixing valve in fluid communication with the series of distribution valves
a water supply in fluid communication with the mixing valve;
at least one of a fire suppressant supply and a fire retardant supply in fluid communication with the mixing valve;
a control unit operatively associated with the series of distribution valves configured to open select distribution valves under predetermined conditions for the routine irrigation of the landscape with water from the water supply; and
a fire sensor operatively associated with the control unit configured to provide an input to the control unit upon detection of a fire, the input causing the control unit to open select distribution valves for non-routine application of at least one of water, fire suppressant and fire retardant to the landscape for fire control.

14. The multipurpose fluid distribution system of claim 13 further comprising:
a pump in fluid communication with the water supply and the series of distribution valves.

15. The multipurpose fluid distribution system of claim 14 further comprising a backup electrical power supply in electrical communication with the pump.

16. The multipurpose fluid distribution system of claim 15 wherein the backup power supply comprises:
a generator in electrical communication with the pump;
a battery in electrical communication with the control unit; and
a switch for the selective application of electrical power to the system from the backup electrical power supply.

17. The multipurpose fluid distribution system of claim 13 further comprising a remote control unit located away from the control unit and in communication with the control unit, the remote control unit being configured to send commands to the control unit causing the control unit to open select distribution valves for non-routine application of at least one of water, fire suppressant and fire retardant to the landscape for fire control.

18. A method of applying fluid to a landscape comprising:
providing a network of fluid distribution heads in association with the landscape;
providing a series of distribution valves in fluid communication with the network of fluid distribution heads;
providing a water supply in fluid communication with the series of distribution valves;
providing a control unit operatively associated with the series of distribution valves;
opening select distribution valves under predetermined conditions for the routine irrigation of the landscape with water from the water supply;
providing a fire sensor operatively associated with the control unit; and opening select distribution valves for non-routine application of water to the landscape upon transmission of an input from the fire sensor to the control unit indicating a fire event.

19. The method of applying fluid to a landscape of claim 18 further comprising providing at least one of a fire retardant supply in fluid communication with the series of distribution valves and a fire suppressant supply in fluid communication with the series of distribution valves such that input from the fire sensor causes the control unit to open select distribution valves for the application of at least one of a fire retardant and a fire suppressant to select features of the landscape.

20. The method of applying fluid to a landscape of claim 19 further comprising providing a mixing valve in fluid communication with the water supply, the fire suppressant supply, the fire retardant supply and the series of distribution valves, such that input from the fire sensor causes the control unit to open select distribution valves causing the application of at least one of a mixture of water and fire retardant and a mixture of water and fire suppressant to select features of the landscape.
